(19) United States
(12) Patent Application Publication
(10) Pub. No.: US 2024/0128009 A1
(43) Pub. Date: Apr. 18, 2024

(54) MAGNETIC DEVICE

(71) Applicant: Delta Electronics, Inc., Taoyuan City (TW)

(72) Inventors: Meng-Chen Hsieh, Taoyuan City (TW); Chun-Ching Yen, Taoyuan City (TW); Huai-Pei Tung, Taoyuan City (TW)

(21) Appl. No.: 18/096,380

(22) Filed: Jan. 12, 2023

(30) Foreign Application Priority Data
Oct. 12, 2022 (CN) 202211247337.3

(51) Int. Cl. H01F 27/28; H01F 27/24; H01F 27/30; H01F 27/32

(52) U.S. Cl. CPC H01F 27/2823; H01F 27/24; H01F 27/306; H01F 27/32

(57) ABSTRACT

A magnetic device includes a magnetic core and at least two windings. The magnetic core includes an annular main body and a hollow portion. Each of the at least two windings includes a coil with a plurality of turns. Each turn of the coil penetrates through the hollow portion and is disposed around the annular main body. The at least two windings are disposed around the annular main body to form at least three winding regions. Each of the winding regions except a winding region which is last formed has at least three winding layers stacked up one by one. The number of the winding layers of the winding regions except the winding region which is last formed is odd and greater than or equal to three.

### CROSS-REFERENCE TO RELATED APPLICATION

This application claims priority to China Patent Application No. 202211247337.3 filed on Oct. 12, 2022, the entire contents of which are incorporated herein by reference for all purposes.

### FIELD OF THE INVENTION

The present disclosure relates to a magnetic device and more particularly to a magnetic device utilizing a winding to form at least three winding regions.

### BACKGROUND OF THE INVENTION

The magnetic devices have been widely used in various electronic products such as communication system, signal process system, filter, etc. to achieve the circuit effect. The magnetic device includes a winding assembly and a magnetic core. In the application, the winding assembly is disposed around the magnetic core by bank winding method. In general, the winding assembly of the conventional magnetic device includes two windings. One is disposed around one side of the magnetic core evenly, and the other is disposed around the other side of the magnetic core evenly. The two windings are maintained a specific distance with each other in the middle portion of the magnetic core and not wrapped around each other. Moreover, a separation plate is disposed in the middle portion of the magnetic core for insulating the two windings. However, the impedance of the conventional magnetic device with bank winding is low. The bandwidth range of the conventional magnetic device with bank winding is not enough to meet the requirements of the electronic product.

Therefore, there is a need of providing a magnetic device to obviate the drawbacks encountered from the prior arts.

### SUMMARY OF THE INVENTION

The present disclosure provides a magnetic device. The magnetic device includes two windings disposed around the annular main body of the magnetic core to form at least three winding regions. All coils located in each winding region except the winding region which is last formed has at least three winding layers stacked up one by one. The number of the winding layers located in each winding region except the winding region which is last formed is odd and greater than or equal to 3. By utilizing the above-mentioned winding method, the impedance and the bandwidth of the magnetic device of the present disclosure are enhanced. The at least two windings of the magnetic device of the present disclosure are fully insulated wires, respectively, and the wires can be wrapped around each other or arranged side by side, such as bifilar windings, to be disposed around and wrapped around the annular main body. Consequently, the magnetic device of the present disclosure can omit the separation plate so as to achieve the advantages of reducing cost.

In accordance with an aspect of the present disclosure, there is provided a magnetic device. The magnetic device includes a magnetic core and at least two windings. The magnetic core includes an annular main body and a hollow portion. Each of the at least two windings includes a coil with a plurality of turns. Each turn of the coil penetrates through the hollow portion and disposed around the annular main body. The at least two windings including the coils with a plurality of turns are disposed around the annular main body to form at least three winding regions. Each of the at least three winding regions except the winding region which is last formed has at least three winding layers stacked up one by one. The number of the winding layers of the at least three winding regions except the winding region which is last formed is odd and greater than or equal to 3.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating a magnetic device according to a first embodiment of the present disclosure;

FIG. 2 is a schematic exploded view illustrating the magnetic device as shown in FIG. 1;

FIG. 3 is a schematic equivalent circuit diagram illustrating a power module using the magnetic device as shown in FIG. 1;

FIG. 4 is a top sectional view illustrating the magnetic device as shown in FIG. 1;

FIG. 5 is a comparison diagram illustrating the impedance and the bandwidth of the magnetic device as shown in FIG. 1 and the conventional magnetic device by utilizing bank winding method; and

FIG. 6 is a top sectional view illustrating a magnetic device according to a second embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this invention are presented herein for purpose of illustration and description only. It is not intended to be exhaustive or to be limited to the precise form disclosed.

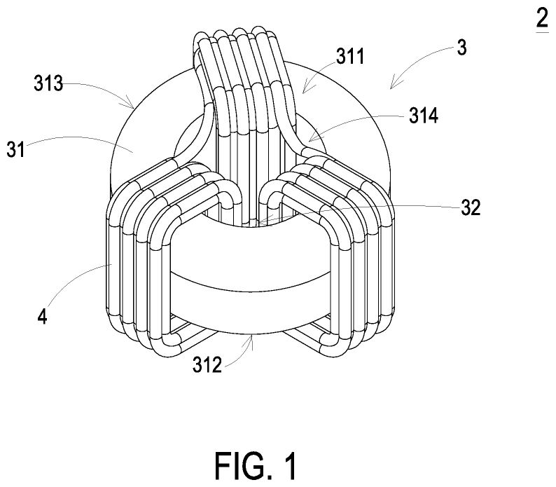

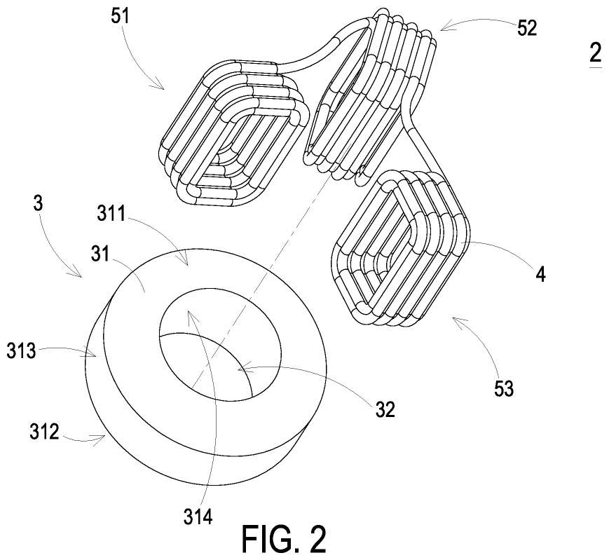

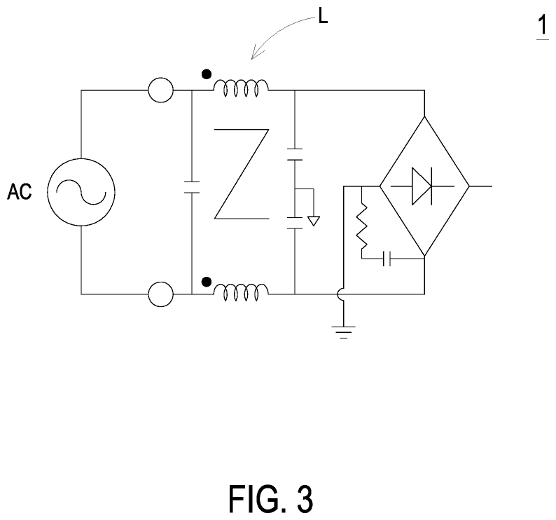

FIG. 1 is a schematic view illustrating a magnetic device according to a first embodiment of the present disclosure. FIG. 2 is a schematic exploded view illustrating the magnetic device as shown in FIG. 1. FIG. 3 is a schematic equivalent circuit diagram illustrating a power module using the magnetic device as shown in FIG. 1. As shown in FIGS. 1 to 3, the magnetic device 2 of the present disclosure is served as a common mode choke L and applied to a power module, for example, a filter. As shown in FIG. 3, the power module 1 receives electric power provided from an alternating current power source AC. The electric power is filtered by the common mode choke L and outputted through an output terminal of the power module 1.

In the practical structure, as shown in FIGS. 1 and 2, the magnetic device 2 includes a magnetic core 3 and at least two windings. In the embodiment, the magnetic core 3 is a cylinder having a hollow structure and includes an annular main body 31 and a hollow portion 32. The annular main body 31 includes a top surface 311, a bottom surface 312, an outer periphery surface 313 and an inner periphery surface 314. The top surface 311 and the bottom surface 312 are opposite to each other. The outer periphery surface 313 and the inner periphery surface 314 are located between the top surface 311 and the bottom surface 312. The outer periphery surface 313 is disposed around the inner periphery surface 314. The inner periphery surface 314 defines the hollow portion 32. Certainly, in some embodiments, the structure of the magnetic core 3 is not limited to the cylinder having the hollow structure and can be shaped as a donut having a hollow structure.

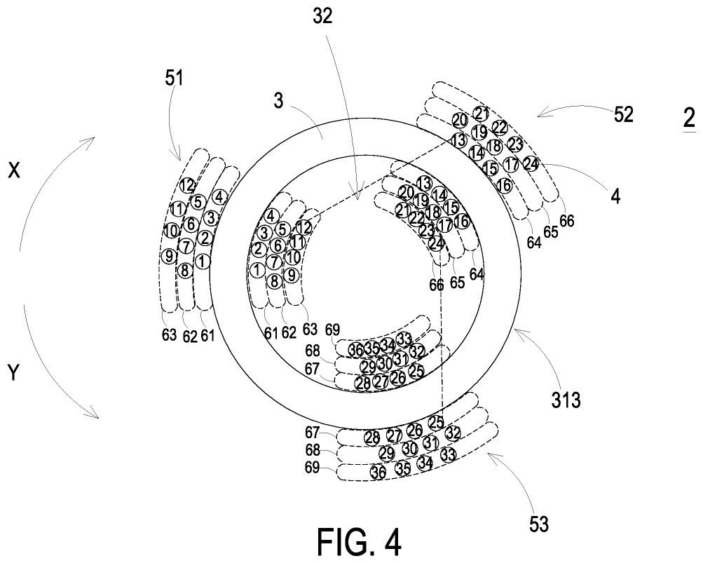

In this embodiment, the at least two windings of the magnetic device 2 are fully insulated wires, respectively, and are stranded wires. For ease of understanding, as shown in FIGS. 1 and 2, the at least two windings stranded with each other are represented as one element, i.e., a winding assembly 4. The withstand voltage of the winding assembly 4 is greater than 1.5 kV. Namely, when the frequency of the voltage is 60 Hz and the voltage generated between the windings is 1800V, the leakage current of the winding assembly 4 is less than or equal to 1 mA. The winding assembly 4 includes a plurality of coils with a plurality of turns. Each turn of the coils is disposed around the annular main body 31 and penetrated through the hollow portion 32. The winding direction of each turn of the coils is from the outer periphery surface 313 of the annular main body 31 toward the inner periphery surface 314 along the top surface 311 (or the bottom surface 312). The plurality of coils of the winding assembly 4 are disposed around the annular main body 31 and separated to form at least three winding regions. As shown in FIG. 2, the at least three winding regions includes a first winding region 51, a second winding region 52 and a third winding region 53. All coils located in each winding region has winding layers stacked up one by one. The number of the winding layers located in different winding regions can be identical or different. As shown in FIG. 4, the plurality of coils of the winding assembly 4 are disposed around the annular main body 31 and separated to form three winding regions, and all coils located in each winding region has at least three winding layers stacked up one by one.

FIG. 4 is a top sectional view illustrating the magnetic device as shown in FIG. 1. As shown in FIG. 4, the numbers labeled in the turns of the coils of the winding assembly 4 are represented as the sequence of the turns of the coils of the winding assembly 4 disposed around the annular main body 31. For example, the number labeled as “1” in the turn of the coil of the winding assembly 4 is represented as the first turn of the coils disposed around the annular main body 31. The number labeled as “2” in the turn of the coil of the winding assembly 4 is represented as the second turn of the coils disposed around the annular main body 31. As shown in FIG. 4, the plurality of coils of the winding assembly 4 disposed around the annular main body 31 form three winding regions, such as the first winding region 51, the second winding region 52 and the third winding region 53 in sequence.

In the first winding region 51, the first turn of the coils, the second turn of the coils, the third turn of the coils and the fourth turn of the coils of the winding assembly 4 are disposed around the annular main body 31 in sequence and has the first winding layer 61 located in the first winding region 51. The winding direction from the first turn of the coils toward the fourth turn of the coils disposed around the annular main body 31 is defined as a first direction X, e.g., the clockwise direction. The fifth turn of the coils, the sixth turn of the coils, the seventh turn of the coils and the eighth turn of the coils of the winding assembly 4 are disposed over the first winding layer 61 in sequence and has the second winding layer 62 located in the first winding region 51. The winding direction from the fifth turn of the coils toward the eighth turn of the coils is defined as a second direction Y, e.g., the counterclockwise direction. The second direction Y is opposite to the first direction X. The ninth turn of the coils, the tenth turn of the coils, the eleventh turn of the coils and the twelfth turn of the coils of the winding assembly 4 are disposed over the second winding layer 62 in sequence and has the third winding layer 63 located in the first winding region 51. The winding direction from the ninth turn of the coils toward the twelfth turn of the coils is defined as the first direction X.

As shown in FIG. 4, in the first winding region 51, the first winding layer 61 is located between the second winding layer 62 and the annular main body 31. The second winding layer 62 is located between the first winding layer 61 and the third winding layer 63. As shown in FIG. 4, the winding directions of the two adjacent winding layers located in the first winding region 51 along the annular main body 31 are opposite to each other. For example, the winding direction of the first winding layer 61 along the annular main body 31 is the first direction X, and the winding direction of the second winding layer 62 along the annular main body 31 is the second direction Y. Namely, the winding direction of the first winding layer 61 along the annular main body 31 is opposite to the winding direction of the second winding layer 62 along the annular main body 31. The winding direction of the second winding layer 62 along the annular main body 31 is the second direction Y, and the winding direction of the third winding layer 63 along the annular main body 31 is the first direction X. Namely, the winding direction of the second winding layer 62 along the annular main body 31 is opposite to the winding direction of the third winding layer 63 along the annular main body 31. Moreover, in the first winding region 51, the winding direction of the winding layer closest to the annular main body 31 is the same with the winding direction of the winding layer most away from the annular main body 31. For example, the first winding layer 61 is closest to the annular main body 31, and the third winding layer 63 is most away from the annular main body 31. The winding direction of the first winding layer 61 along the annular main body 31 is the first direction X, and the winding direction of the third winding layer 63 along the annular main body 31 is also the first direction X. Namely, the winding direction of the first winding layer 61 along the annular main body 31 is the same with the winding direction of the third winding layer 63 along the annular main body 31.

The thirteenth turn of the coils located in the second winding region 52 is connected with the twelfth turn of the coils located in the first winding region 51 of the winding assembly 4, as shown the dotted line in FIG. 4. In the second winding region 52, the thirteenth turn of the coils, the fourteenth turn of the coils, the fifteenth turn of the coils and the sixteenth turn of the coils of the winding assembly 4 are disposed around the annular main body 31 in sequence and has the first winding layer 64 located in the second winding region 52. The winding direction from the thirteenth turn of the coils toward the sixteenth turn of the coils disposed around the annular main body 31 is defined as a first direction X, e.g., the clockwise direction. The seventeenth turn of the coils, the eighteenth turn of the coils, the nineteenth turn of the coils and the twentieth turn of the coils of the winding assembly 4 are disposed over the first winding layer 64 in sequence and has the second winding layer 65 located in the second winding region 52. The winding direction from the seventeenth turn of the coils toward the twentieth turn of the coils is defined as a second direction Y, e.g., the counterclockwise direction. The second direction Y is opposite to the first direction X. The twenty-first turn of the coils, the twenty-second turn of the coils, the twenty-third turn of the coils and the twenty-fourth turn of the coils of the winding assembly 4 are disposed over the second winding layer 65 in sequence and has the third winding layer 66 located in the second winding region 52. The winding direction from the twenty-first turn of the coils toward the twenty-fourth turn of the coils is defined as the first direction X.

As shown in FIG. 4, in the second winding region 52, the first winding layer 64 is located between the second winding layer 65 and the annular main body 31. The second winding layer 65 is located between the first winding layer 64 and the third winding layer 66. As shown in FIG. 4, the winding directions of the two adjacent winding layers located in the second winding region 52 along the annular main body 31 are opposite to each other. For example, the winding direction of the first winding layer 64 along the annular main body 31 is the first direction X, and the winding direction of the second winding layer 65 along the annular main body 31 is the second direction Y. Namely, the winding direction of the first winding layer 64 along the annular main body 31 is opposite to the winding direction of the second winding layer 65 along the annular main body 31. The winding direction of the second winding layer 65 along the annular main body 31 is the second direction Y, and the winding direction of the third winding layer 66 along the annular main body 31 is the first direction X. Namely, the winding direction of the second winding layer 65 along the annular main body 31 is opposite to the winding direction of the third winding layer 66 along the annular main body 31. Moreover, in the second winding region 52, the winding direction of the winding layer closest to the annular main body 31 is the same with the winding direction of the winding layers most away from the annular main body 31. For example, the first winding layer 64 is closest to the annular main body 31, and the third winding layer 66 is most away from the annular main body 31. The winding direction of the first winding layer 64 along the annular main body 31 is the first direction X, and the winding direction of the third winding layer 66 along the annular main body 31 is also the first direction X. Namely, the winding direction of the first winding layer 64 along the annular main body 31 is the same with the winding direction of the third winding layer 66 along the annular main body 31.

The twenty-fifth turn of the coils located in the third winding region 53 is connected with the twenty-fourth turn of the coils located in the second winding region 52 of the winding assembly 4, as shown the dotted line in FIG. 4. In the third winding region 53, the twenty-fifth turn of the coils, the twenty-sixth turn of the coils, the twenty-seventh turn of the coils and the twenty-eighth turn of the coils of the winding assembly 4 are disposed around the annular main body 31 in sequence and has the first winding layer 67 located in the third winding region 53. The winding direction from the twenty-fifth turn of the coils toward the twenty-eighth turn of the coils disposed around the annular main body 31 is defined as a first direction X, e.g., the clockwise direction. The twenty-ninth turn of the coils, the thirteenth turn of the coils, the thirty-first turn of the coils and the thirty-second turn of the coils of the winding assembly 4 are disposed over the first winding layer 67 in sequence and has the second winding layer 68 located in the third winding region 53. The winding direction from the twenty-ninth turn of the coils toward the thirty-second turn of the coils is defined as a second direction Y, e.g., the counterclockwise direction. The second direction Y is opposite to the first direction X. The thirty-third turn of the coils, the thirty-fourth turn of the coils, the thirty-fifth turn of the coils and the thirty-sixth turn of the coils of the winding assembly 4 are disposed over the second winding layer 68 in sequence and has the third winding layer 69 located in the third winding region 53. The winding direction from the thirty-third turn of the coils toward the thirty-sixth turn of the coils is defined as the first direction X.

As shown in FIG. 4, in the third winding region 53, the first winding layer 67 is located between the second winding layer 68 and the annular main body 31. The second winding layer 68 is located between the first winding layer 67 and the third winding layer 69. As shown in FIG. 4, the winding directions of the two adjacent winding layers located in the third winding region 53 along the annular main body 31 are opposite to each other. For example, the winding direction of the first winding layer 67 along the annular main body 31 is the first direction X, and the winding direction of the second winding layer 68 along the annular main body 31 is the second direction Y. Namely, the winding direction of the first winding layer 67 along the annular main body 31 is opposite to the winding direction of the second winding layer 68 along the annular main body 31. The winding direction of the second winding layer 68 along the annular main body 31 is the second direction Y, and the winding direction of the third winding layer 69 along the annular main body 31 is the first direction X. Namely, the winding direction of the second winding layer 68 along the annular main body 31 is opposite to the winding direction of the third winding layer 69 along the annular main body 31. Moreover, in the third winding region 53, the winding direction of the winding layer closest to the annular main body 31 is the same with the winding direction of the winding layer most away from the annular main body 31. For example, the first winding layer 67 is closest to the annular main body 31, and the third winding layer 69 is most away from the annular main body 31. The winding direction of the first winding layer 67 along the annular main body 31 is the first direction X, and the winding direction of the third winding layer 69 along the annular main body 31 is also the first direction X. Namely, the winding direction of the first winding layer 67 along the annular main body 31 is the same with the winding direction of the third winding layer 69 along the annular main body 31.

As shown in FIG. 4, the winding direction of the winding layer most away from the annular main body 31 located in the first winding region 51 along the annular main body 31 (i.e., the third winding layer 63) is the first direction X, which is the same with the winding direction of the winding layer most away from the annular main body 31 located in the second winding region 52 along the annular main body 31 (i.e., the third winding layer 66) and the winding direction of the winding layer most away from the annular main body 31 located in the third winding region 53 along the annular main body 31 (i.e., the third winding layer 69).

In the above embodiment, the winding assembly 4 of the magnetic device 2 forms three winding regions, and the number of the winding layers located in each winding region is three. As shown in FIG. 4, the winding regions are formed one by one, and the first winding region is first formed as an entry terminal, and the third winding region 53 is last formed as an exit terminal. Moreover, the winding layer most away from the annular main body 31 located in any winding region is connected with the winding layer closest to the annular main body 31 located in the next winding region. Namely, the two adjacent winding regions are distinguished as the above connection relationship. Certainly, in some embodiments, the number of the winding region formed by the plurality of coils of the winding assembly 4 disposed around the annular main body 31 is not limited to three and can be equal to or more than four. In some embodiments, the number of the winding layer located in each winding region is not limited to three and can be five, seven or more than seven. The number of the winding layer located in each winding region except the winding region which is last formed is odd. The number of the winding layer located in each winding region can be identical or different.

In some embodiments, the number of the winding layer located in the winding region which is last formed is one. Namely, the third winding region 53 only includes the first winding layer 67. As shown in FIG. 4, the winding direction of the first winding layer 67 located in the third winding region 53 along the annular main body 31 is the same with the winding direction of the winding layer most away from the annular main body 31 (i.e., the third winding layer 66) located in the second winding region 52 along the annular main body 31 and the winding direction of the winding layer most away from the annular main body 31 (i.e., the third winding layer 63) located in the first winding region 51 along the annular main body 31. Namely, the winding direction of the first winding layer 67 located in the third winding region 53 along the annular main body 31, the winding direction of the third winding layer 66 located in the second winding region 52 along the annular main body 31 and the winding direction of the third winding layer 63 located in the first winding region 51 along the annular main body 31 are the first direction X, respectively.

Certainly, in some embodiments, the number of the winding layer located in the winding region which is last formed is two. Namely, the third winding region 53 only includes the first winding layer 67 and the second winding layer 68. As shown in FIG. 4, the winding direction of the second winding layer 68 located in the third winding region 53 along the annular main body 31 is opposite to the winding direction of the winding layer most away from the annular main body 31 (i.e., the third winding layer 66) located in the second winding region 52 along the annular main body 31 and the winding direction of the winding layer most away from the annular main body 31 (i.e., the third winding layer 63) located in the first winding region 51 along the annular main body 31. Namely, the winding direction of the second winding layer 68 located in the third winding region 53 along the annular main body 31 is the second direction Y. The winding direction of the third winding layer 66 located in the second winding region 52 along the annular main body 31 and the winding direction of the third winding layer 63 located in the first winding region 51 along the annular main body 31 are the first direction X, respectively. Certainly, in some embodiments, the number of the winding layer located in the winding region which is last formed is even and more than two.

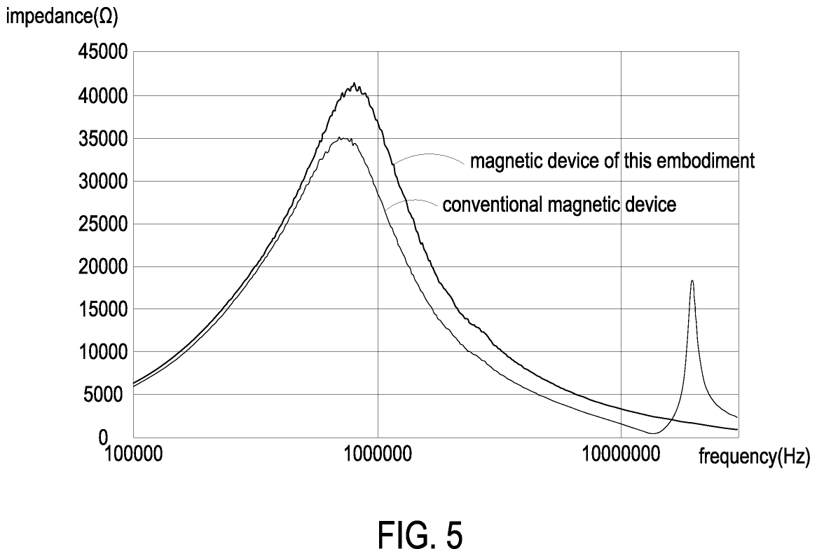

FIG. 5 is a comparison diagram illustrating the impedance and the bandwidth of the magnetic device as shown in FIG. 1 and the conventional magnetic device by utilizing bank winding method. As shown in FIG. 5, the impedances and the bandwidths of the conventional magnetic device and the magnetic device 2 of FIG. 1 are shown. It is noted that the impedance of the conventional magnetic device with bank windings is about 35000Ω, and the impedance of the magnetic device 2 of this embodiment is about 41000Ω. Consequently, the impedance of the magnetic device 2 of this embodiment is greater than the impedance of the conventional magnetic device with bank windings. Moreover, when the impedance is greater than or equal to 20000Ω, the bandwidth of the magnetic device 2 of this embodiment is obviously greater than the bandwidth of the conventional magnetic device with bank windings.

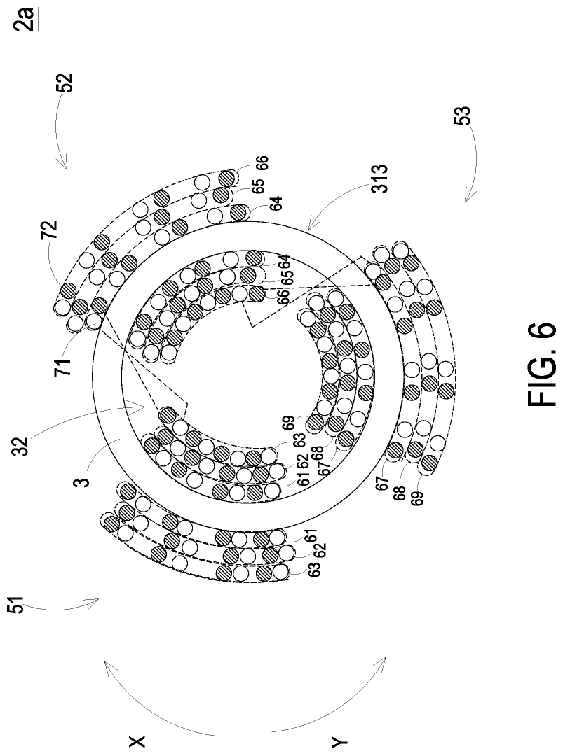

FIG. 6 is a top sectional view illustrating a magnetic device according to a second embodiment of the present disclosure. The at least two windings of the magnetic assembly are not limited to be wrapped around each other. In some embodiments, the at least two windings of the magnetic assembly are bifilar windings disposed around the annular main body in parallel. As shown in FIG. 6, the at least two windings of the magnetic device 2a of this embodiment includes a first winding 71 and a second winding 72. The blank circle shown in FIG. 6 represents the cross section of the first winding 71, and the oblique circle shown in FIG. 6 represents the cross section of the second winding 72. The first winding 71 and the second winding 72 are disposed around the annular main body 31 side by side. The winding method of the first winding 71 and the second winding 72 of this embodiment is similar to the winding method of the winding assembly 4 of the first embodiment, and is not redundantly described hereinafter. Certainly, in some embodiments, the number of the winding region formed by the plurality of coils of the first winding 71 and the second winding 72 disposed around the annular main body 31 is not limited to three and can be equal to or more than four. In some embodiments, the number of the winding layer located in each winding region is not limited to three and can be five, seven or more than seven. The number of the winding layer located in each winding region except the winding region which is last formed is odd and greater than or equal to three. The number of the winding layer of each winding region can be identical or different.

As mentioned above, the magnetic device includes two windings disposed around the annular main body of the magnetic core to form at least three winding regions. All coils located in each winding region except the winding region which is last formed has at least three winding layers stacked up one by one. The number of the winding layers located in each winding region except the winding region which is last formed is odd and greater than or equal to three. Compared with the conventional magnetic device by utilizing the bank winding method, the impedance and the bandwidth of the magnetic device of the present disclosure are enhanced. The at least two windings of the magnetic device of the present disclosure are fully insulated wires, respectively, and the wires can be wrapped around each other or arranged side by side, such as bifilar windings, to be disposed around and wrapped around the annular main body. Compared with the conventional magnetic device by utilizing the separation plate, the magnetic device of the present disclosure can omit the separation plate so as to achieve the advantages of reducing cost.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A magnetic device, comprising:
a magnetic core comprising an annular main body and a hollow portion; and
at least two windings, each of the at least two windings comprising a coil with a plurality of turns, each turn of the coil penetrating through the hollow portion and disposed around the annular main body, wherein the at least two windings comprising the coils with a plurality of turns are disposed around the annular main body to form at least three winding regions, each of the at least three winding regions except the winding region which is last formed has at least three winding layers stacked up one by one, and the number of the winding layers of each of the at least three winding regions except the winding region which is last formed is odd and greater than or equal to three.

2. The magnetic device according to claim 1, wherein winding directions of the two adjacent winding layers in any of the winding regions except the winding region which is last formed along the annular main body are opposite to each other, and a first winding direction of the winding layer closest to the annular main body in any of the winding regions except the winding region which is last formed is the same with a second winding direction of the winding layer most away from the annular main body in the same winding region.

3. The magnetic device according to claim 2, wherein the winding region which is last formed has at least one winding layer, the number of the winding layer in the winding region which is last formed is odd, and a third winding direction of the winding layer most away from the annular main body in the winding region which is last formed is the same with the second winding direction of the winding layer most away from the annular main body in any of the winding regions except the winding region which is last formed.

4. The magnetic device according to claim 2, wherein the winding region which is last formed has at least two winding layers, the number of the winding layers in the winding region which is last formed is even, and a fourth winding direction of the winding layer most away from the annular main body in the winding region which is last formed is opposite to the second winding direction of the winding layer most away from the annular main body in any of the winding regions except the winding region which is last formed.

5. The magnetic device according to claim 1, wherein the winding layers in any of the at least three winding regions comprises a first winding layer, a second winding layer and a third winding layer, wherein the first winding layer is closest to the annular main body, the third winding layer is most away from the annular main body, and the second winding layer is stacked between the first winding layer and the third winding layer, wherein a winding direction of the first winding layer along the annular main body is the same with a winding direction of the third winding layer along the annular main body, and a winding direction of the second winding layer along the annular main body is opposite to the winding direction of the first winding layer along the annular main body.

6. The magnetic device according to claim 1, wherein the winding regions comprises a first winding region, a second winding region and a third winding region, wherein the first winding region, the second winding region and the third region are disposed around the annular main body of the magnetic core in sequence, wherein the winding layer most away from the annular main body in the first winding region is connected with the winding layer closest to the annular main body in the second winding region, and the winding layer most away from the annular main body in the second winding region is connected with the winding layer closest to the annular main body in the third winding region.

7. The magnetic device according to claim 1, wherein the withstand voltage of the at least two windings are greater than 1.5 kV.

8. The magnetic device according to claim 1, wherein the at least two windings comprise two wires wrapped around each other and disposed around the annular main body.

9. The magnetic device according to claim 1, wherein the at least two windings are bifilar windings comprising two winding wires arranged in parallel.

10. The magnetic device according to claim 1, wherein the at least two windings are fully insulated wires.
